(19) United States
(12) Patent Application Publication
(10) Pub. No.: US 2020/0010717 A1
(43) Pub. Date: Jan. 9, 2020

(54) POWDER COATING COMPOSITION

(71) Applicant: TIGER COATINGS GMBH & CO. KG, Wels (AT)

(72) Inventors: Bernhard BRÜSTLE, Zipf (AT); Gerd SCHLAGER, Wels (AT)

(21) Appl. No.: 16/486,876

(22) PCT Filed: Feb. 20, 2018
(86) PCT No.: PCT/EP2018/054089

§ 371 Date: Aug. 19, 2019

(30) Foreign Application Priority Data
Feb. 20, 2017 (EP) 17157015.3

(51) Int. Cl. C09D 167/00; C09D 163/00; C09D 5/03

(52) U.S. Cl. CPC C09D 167/00; C08K 5/5393; C09D 5/033; C09D 163/00

(57) ABSTRACT

The invention relates to a powder coating composition containing a binder combination. The binder combination comprises the following components: A) 15 to 70 wt. % of the binder of one or more amorphous carboxyl group-containing polyester resins, having an arithmetically averaged acid number of 50 to 100 mg KOH/g, B) 20 to 50 wt. % of the binder of one or more epoxide group-containing polymers with an arithmetically averaged epoxide equivalent weight of 350 to 650 g/eq, preferably 400 to 650 g/eq, preferably based on bisphenol A and phenol novolak, C) 5 to 55 wt. % of the binder of one or more crystalline or semi-crystalline carboxyl group-containing polyester resins, having an arithmetically averaged acid number of 15 to 00 mg KOH/g, D) 0.5 to 6 wt. % (based on the entire formulation) of one or more catalysts (accelerants) for the crosslinking reaction(s), and optionally E) 0 to 10 wt. % (based on the entire formulation) of one or more components with reactive groups for the crosslinking reaction(s) with the carboxyl groups and/or epoxide groups of the components A), B), and C). The polyester resins according to A) and. C) contain a sum of 15 to 75 wt. %, preferably 15 to 60 wt. % and particularly preferably 20 to 50 wt. %, based on the monomers used for the synthesis, of linear and unbranched aliphatic diols or the derivatives thereof and/or linear and unbranched aliphatic dicarboxylic acids or the derivatives thereof. The invention additionally relates to a method for producing such a powder coating composition and to the use thereof.

### FIELD OF THE INVENTION

The present invention relates to powder coating systems which can be cured at very low baking temperatures and which have very good deformability.

The powder coatings in accordance with the invention contain (semi)crystalline components and can be used to coat a very wide variety of substrates. In particular, heat-sensitive substrates such as wood materials can be coated at low baking temperatures and with short baking times in order to obtain smooth or textured powder coated surfaces with good mechanical properties. Because of the improved properties, in particular the improved flexibility and deformability, single coats of these powder coatings can be used on wood materials with a low risk of crack formation due to variations in the dimensions of the substrate. The invention encompasses low temperature powder coatings, both with smooth and also with textured surfaces and with different gloss levels from dull matt to high gloss.

### BACKGROUND

In order to coat heat-sensitive substrates, as a rule, accelerated epoxy/polyester powder coatings (hybrid powder coatings) are used. These are characterized by low baking temperatures and a substantially better UV resistance compared with pure epoxy resin powder coatings.

In the present description, the term “highly reactive powder coatings” or “ low baking temperatures” (low temperature or low-cure powder coatings) means that the powder coatings can be used to coat heat-sensitive substrates such as LDF/MDF/HDF wood fibre board or particle board, for example. The curing temperatures and baking times have to be so short that essentially no thermal damage of the substrate and the coating occurs. In the prior art, powder coatings for heat-sensitive substrates are used which can be cured within 3 min to 5 min at a substrate surface temperature of 135° C. to 150° C. The highly reactive powder coatings disclosed in the present description exhibit good properties under these baking conditions and if necessary also under even milder baking conditions of, for example, 2 min to 5 min at a substrate surface temperature of 130° C. to 140° C.; these are necessary for a very wide variety of applications, such as in the furniture industry, for example.

The stability upon storage of the powder coating is a decisive factor for the potential applications of the powder coating. In the context of the present description, the stability upon storage is defined as satisfactory if, after storage of the powder coating for two weeks at an ambient temperature of 30° C., the coat quality of the powder coating has not deteriorated. Preferably, the properties of the cured powder coating film do not deteriorate after storage for 4 weeks at 30° C. It is assumed that at lower storage temperatures, such as below 20° C., for example, the powder coatings are stable upon storage for a correspondingly longer period, in order to be suitable for industrial use. The quality of the powder coatings was assessed in the context of stability upon storage tests primarily with the aid of gel time measurements in conformity with ÖNORM EN ISO 8130-6. The gel time measurements were carried out at a temperature of 130° C. for the heated blocks. In contrast to that specified in the standard, the time measurement was started immediately after transferring the powder coating test portion into the depression in the heated block rather than after the powder has completely melted. If, before and after storage, differences of more than 50% in the gel time were observed for the gel time measurements, then the stability upon storage was interpreted as being insufficient.

In addition, powder coatings must have a very good, good or at least acceptable physical stability upon storage. If the powder coating exhibits no clumping after storage for four weeks at 30° C., the physical stability upon storage is judged to be very good. If the powder coating displays no clumping after storage for two weeks at 30° C., the physical stability upon storage is judged to be good. If the powder coating displays no clumping after storage for one week at 30° C., the physical stability upon storage is judged to be acceptable, and below this, the physical stability upon storage is judged to be unacceptable.

In order to cure the powder coating, it has to be melted in an oven and then thermally cross-linked. For thermal cross-linking, at least the baking conditions specified above have to be observed. The substrate coated with powder coating is thus exposed to the curing temperatures or baking temperatures for the powder coating for a specific period. For melting and curing, a variety of oven technologies may be employed, such as convection ovens, infrared ovens or combinations thereof. Infrared ovens are preferred because they heat up the substrate surface faster. In this manner, complete heating of the substrate is avoided and fewer problems involving thermal damage or outgassing of the substrate arise.

Accelerated hybrid powder coatings usually do not have sufficient mechanical properties or flexibility and deformability to be capable of being used in single coats on wood materials such as LDF/MDF/HDF. For this reason, various powder coating manufacturers developed coating systems which require two coats to be built up. A special powder coating primer guarantees the mechanical properties and prevents crack formation in the topcoat, which in turn safeguards the demanded surface properties.

There is a huge demand for low temperature powder coatings which only have to be applied as a single coat and which have good crack resistance, in particular from the furniture industry and their suppliers such as, for example MDF (medium density fibreboard) powder coating manufacturers. The main advantages of single coat application are the low investment in plant or higher possible throughput rates for the same oven capacity and a reduced thermal load on the substrate. A further advantage is that a larger selection of temperature-sensitive substrates may be employed. With primer coating, wood materials such as medium density fibreboard (MDF) can dry out, whereupon the conductivity of the substrate is reduced and problems with the electrostatic application of the topcoat may arise. For this reason, for two-coat applications, special MDF boards with improved conductivity are used (for example “MBP-L” type MDF from Egger), but these cost more. For single-coat topcoat applications, it is possible to use standard MDF boards, which are less expensive.

In addition to the single layer topcoats, above all low temperature powder coatings which have a smooth surface are demanded. Because of the high reactivity, it is difficult to obtain smooth coatings with low temperature powder coatings, because only a short period is available following melting for the powder coating to flow and for the formation of a smooth surface before the curing reaction is initiated. The start of cross-linking increases the melt viscosity of the powder coating and it can no longer flow. Thus, highly reactive powder coatings usually exhibit what is known as an orange peel surface and are preferably formulated and used as textured powder coatings. The powder coating formulations in accordance with the invention produce a significantly smoother surface because they have a lower melt viscosity. In this manner, flowing in the molten phase is better and smooth formulations are possible.

In addition to the mentioned demands, unproved UV resistance over standard epoxy/polyester hybrid powder coatings is demanded which, because of the epoxy resin contained in them, are severely limited as regards light fastness. Yellowing may occur with powder coatings of this type, after several years' use indoors. Light stabilizers and antioxidants cannot inhibit this yellowing and the light fastness can thus not be improved in this manner. In a specifically adapted embodiment of the powder coatings in accordance with the invention, in this regard, a significant improvement over the prior art can be achieved.

Documents have been published in which powder coating formulations are described which use a combination of amorphous polyester resins and (semi)crystalline polyester resins and which include carboxy groups. Various hardeners for cross-linking these polyester resins have been used, such as epoxy-functional hardeners and resins (for example Araldite PT910, BPA-based epoxy resins, GMA acrylate resins, etc) or beta-hydroxyalkylamide compounds (for example Primid). The advantage of acrylate resins over BPA-based epoxy resins lies in a better UV resistance, meaning that they can be used outdoors. However, for highly reactive powder coatings, epoxy-functional acrylate resins cannot be used, because their reactivity is too low.

Powder coating wood materials such as MDF places great demands on the coating process. Among other things, the surface temperature on all surfaces and edges of the three-dimensional substrate have to be very closely controlled. Curing must be sufficient on all edges in order to safeguard the properties of the powder coating. On the other hand, the thermal load has to be kept as low as possible in order to avoid damage and outgassing of the substrate, or to keep it low. For this reason, the low temperature powder coatings are usually only cross-linked at the lower limit of the baking window, which places great demands on the oven technology and on the oven settings in order to keep the temperatures within a very narrow range. It would be of great advantage to be able to widen this processing window without causing problems with quality in doing so. Surprisingly, it has been shown that the powder coatings disclosed in the present description are more robust and, when slight under-curing occurs, do not exhibit such a severe decline in mechanical properties (for example no crack formation upon deformation or when testing in conformity with IOS-TM-0022) than low temperature powder coatings known up to now is based on what is known as a hybrid of polyester and epoxy resin. Accelerated hybrid powder coatings of the prior art exhibit a severe decline in mechanical properties when they are not completely cured.

Coated wood materials are often used in the furniture industry where, in addition to textured surfaces, smooth surfaces with low gloss levels are especially demanded. The smooth surfaces usually have a gloss level of less than 60 gloss units (at a measuring angle of) 60°, preferably less than 50 gloss units (at a measuring angle of)60°. To manufacture coated furniture parts, wet paints are primarily used because these can produce a sufficiently smooth surface and also provide for low gloss levels. The demands on the powder coating are thus, in addition to as smooth a surface as possible, also as low a gloss level as possible. For low temperature powder coatings, however, no mattification methods are known which, with the cited low baking temperatures of below 150° C., can produce low gloss levels of less than 50 gloss units (at a measuring angle of)60°. By adding large quantities of mattification waxes, gloss levels of less than 50 gloss units (at a measuring angle of)60° may be produced. However, these methods do not deliver stable mattification, because the surfaces can be polished, whereupon the gloss level can be raised to more than 50 gloss units (at a measuring angle of 60°).

For more than a decade, attempts have been made to develop low temperature powder coatings which satisfy the demands mentioned above. In the present description, powder coating formulations are disclosed which, because of a very specific composition, are surprisingly highly reactive and at the same time are stable upon storage, are suitable for use as a single coat powder coating for heat-sensitive substrates and also can be used to produce smooth surfaces. In addition, formulations are described which have a better light fastness. The powder coating in accordance with the invention which can be produced in this manner thus provides a spectrum of application which up to now was not accessible to hybrid powder coatings of the prior art which are based on polyester and epoxy resins.

WO 2004/041904 A1 describes a powder coating composition which contains amorphous polyester resins and semi-crystalline polyester resins together with “polyphenoxy” resins which have an epoxy equivalent weight EEW of 150 to 1500 g/eq. Bisphenol A based epoxy resins and phenol or cresol-epoxy novolaks are named as the “polyphenoxy” resins. No highly reactive powder coatings are described in that document. The ranges given for the acid value of the amorphous polyester and for the EEW of the “polyphenoxy” component are not suitable for highly reactive powder coatings. No solutions are disclosed for accelerating low temperature powder coatings to obtain the baking conditions necessary for coating heat-sensitive substrates while providing the powder coating with a sufficient stability upon storage.

DE 102006057837 A1 discloses a powder coating composition which contains both (semi)crystalline polyesters as well as amorphous polyesters and which are cross-linked by means of a hardener that contains epoxy groups and/or hydroxyalkylamide groups. No highly reactive powder coatings are described in that document.

U.S. Pat. No. 6,184,311 B1 or WO 91/14745 describe a binder composition of a semi-crystalline and an amorphous polyester resin which has carboxy groups which can be cured with epoxy resins or other reactive groups. The hybrid powder coatings described, however, are not highly reactive powder coatings. The ranges given for the acid value of the amorphous polyester, EEW, of the epoxy resin as well as the type and quantity of the catalyst do not indicate that it can be applied to a highly reactive powder coating. In the case of the claimed large quantities of semi-crystalline polyester of up to 100 percent by weight of polyester resin, the powder coatings are no longer sufficiently stable upon storage according to the definition given in the present description.

U.S. Pat. No. 6,660,398 B1 in turn describes the combination of semi-crystalline polyester resins with amorphous polyester resins. The claimed semi-crystalline polyester consists, inter alia, of 1,12-dodecanedioic acid, and according to the description has a preferred acid value of less than 30 mg KOH/g. The powder coating is not a hybrid powder coating and not a low temperature powder coating. The hardeners given are glycidyl esters such as TGIC and Araldite PT 910 as well as hydroxyalkylamides such as Primid XL-552.

### SUMMARY OF THE INVENTION

In the context of the present invention, it has surprisingly been observed that highly reactive hybrid powder coatings based on epoxy and polyester resins with the addition of (semi)crystalline resins—which are very specific in a preferred embodiment can be produced which have very good mechanical properties and deformability. It is thus possible to use low temperature powder coatings for single-layer coating of wood materials. In addition, adding the (semi)crystalline resin brings about a reduction in the melt viscosity, whereupon smooth surfaces can be obtained for highly reactive powder coatings.

### BRIEF DESCRIPTION OF THE DRAWINGS

FIG. 1 Rheology measurements (AR 2000ex from TA Instruments) for complex viscosity η*.

FIG. 2 Deformation at edge of powder coated MDF after IOS-TM-0022 test.

### DETAILED DESCRIPTION OF THE INVENTION

The present invention concerns a powder coating formulation which contains a special binder combination that is accelerated by means of special catalysts in order to obtain a highly reactive powder coating. The binder is composed of at least three components, an amorphous polyester resin, a (semi)crystalline polyester resin and an epoxy resin. The polyester resins contain carboxy groups which react with the epoxy groups during the baking process, resulting in a chemically cross-linked powder coated film.

Thus, the powder coating in accordance with the invention contains a binder combination comprising the following components:

A) 15% to 70% by weight of the binder formed by one or more amorphous polyester resins containing carboxy groups, with an arithmetically averaged acid value* of 50 to 100 mg KOH/g,

B) 20% to 50% by weight of the binder formed by one or more polymers containing epoxy groups with an arithmetically averaged epoxy equivalent weight of 350 to 650 g/eq, preferably of 400 to 650 g/eq, preferably based on bisphenol A and phenol novolak,

C) 5% to 55% by weight of the binder formed by one or more crystalline or semi-crystalline polyester resins containing carboxy groups, with an arithmetically averaged acid value of 15 to 100 mg KOH/g,

D) 0.5% to 6% by weight (with respect to the whole formulation) formed by one or more catalysts (accelerators) for the cross-linking reaction(s), and optionally

E) 0 to 10% by weight (with respect to the whole formulation) formed by one or more components containing reactive groups for cross-linking reaction(s) with the carboxy groups and/or epoxy groups of the components A), B) and C),

wherein the polyester resins in accordance with A) and C) contain a total of 15% to 75% by weight, preferably 15% to 60% by weight and particularly preferably 20% to 50%, by weight with respect to the monomer used for synthesis, of linear and unbranched aliphatic diols or their derivatives and/or linear and unbranched aliphatic dicarboxylic acids or their derivatives. *The averaged acid value is calculated from the acid values for the individual components and their proportions, for example component A) consists of 80% polyester with an acid value of 80 mg KOH/g and 20% polyester with an acid value of 40 mg KOH/g. The averaged acid value of component A) is thus (0.8*80)+(0.2*40)=64+8=72.

In the case in which the sum of the proportions of the individual components A) to D) as well as, optionally, A) to E), is not 100% by weight, then the remainder to 100% by weight is provided by fillers which are known and usual in the prior art.

It has been shown that by adding a special (semi)crystalline polyester resin as given above with an averaged acid value of 15 to 100 mg KOH/g, a hybrid powder coating is obtained which exhibits very good deformability. At the same time, it has been shown that by adding these (semi)crystalline components, the reactivity of the powder coating can be reduced, whereupon it is no longer sufficiently reactive for coating temperature sensitive substrates such as MDF wood fibreboard, for example. Surprisingly, it has now been discovered that with combinations of the crystalline polyesters with the very specific epoxy resins given above with a narrow range for the epoxy equivalent weight (EEW) from 350 to 650 g/eq, preferably from 400 to 650 g/eq, with amorphous polyester resins which have a relatively high acid value of 50 to 100 mg KOH/g, and with special catalysts, the reactivity can be raised to a level which is high enough for the powder coating to be able to be cured after 3 min to 5 min at 135° C. to 150° C. (substrate surface temperature) and higher. Thus, in accordance with the invention, a powder coating is obtained which is highly reactive, has a high deformability and, because of its cross-linking density, provides a resistant coated surface. By adding the (semi)crystalline component, it is possible to produce low temperature powder coatings which have a significantly smoother surface compared with normal low temperature powder coatings. By means of the (semi)crystalline components, the melt viscosity is severely reduced, whereupon the powder coating can flow better upon melting and the orange peel effect which is typical with highly reactive powder coatings is avoided.

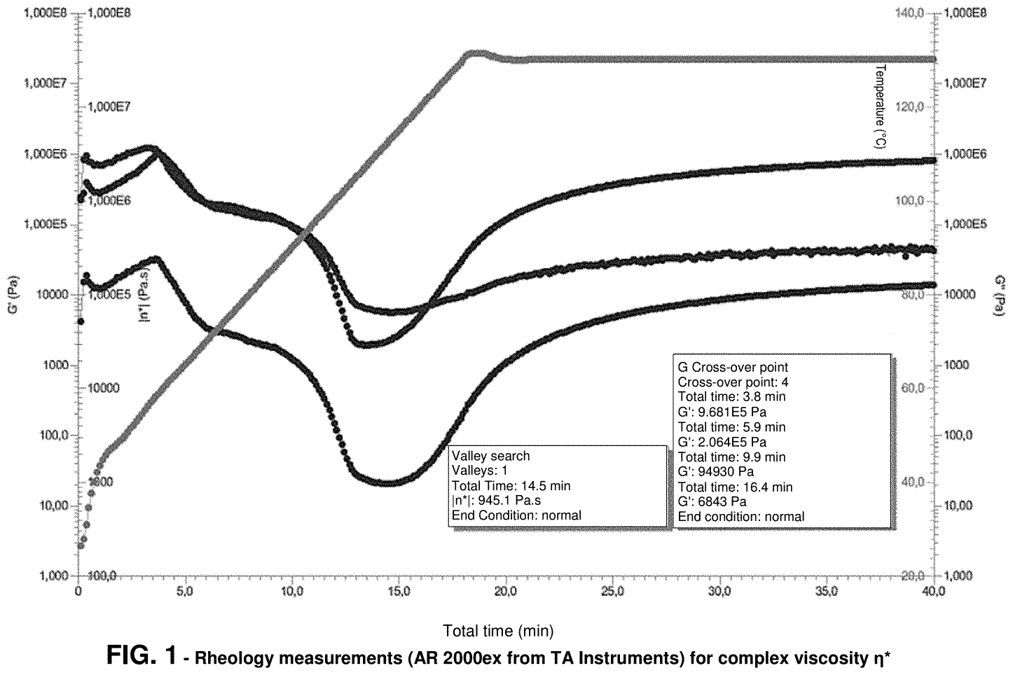

The melt viscosity of the powder coating can be measured using a rheometer such as the “AR 2000ex” from TA Instruments Ltd, at a specific heating rate. In these rheological measurements, using the storage modulus G′ and the loss modulus G″, the complex viscosity η* can be determined. With the aid of the minimum of the complex viscosity, the melt viscosity of the powder coating can be assessed (FIG. 1). It has been shown that for powder coated surfaces which are as smooth as possible, the minimum of the complex viscosity when measured using plate-plate measurement geometry at a heating rate of 5° C./min should be in the range of 300 to 4000 Pa*s, preferably in the range 300 to 2000 Pa*s.

Preferably, the stoichiometric ratio of the carboxy groups from the components A) and C) to the epoxy groups from component B) is in the range from 0.3 to 1.5, preferably in the range from 0.8 to 1.2 and particularly preferably in the range from 0.9 to 1.1. When an additional component E) is employed, this must be included in the calculation of the stoichiometric ratio (for example, when adding a polyamine, depending on the amine value, fewer epoxy groups are available for the reaction with the carboxy groups because they also react with the amine groups). Although an excess of carboxy groups is of little advantage in conventional powder coating formulations from the prior art, because they are not cross-linked, an excess of epoxy is advantageous in the invention because the epoxy groups can also cross-link by homopolymerization.

Advantageously again, the linear and unbranched aliphatic diols and/or aliphatic dicarboxylic acids in the polyester resins in accordance with A) and C) do not contain any double and/or triple bonds in their carbon chains. Surprisingly, it has been shown that these unsaturated bonds have a negative influence on the deformability and thus on the water swelling test resistance of the prepared powder coating.

When the proportion of (semi)crystalline resins in the formulation is high, typically, problems occur with the stability upon storage of the powder coating. By means of the (semi)crystalline resin, the glass transition temperature of the powder coating is reduced, whereupon problems may arise with the powder coating production process, with storage and transport as well as when used in the coating equipment. Surprisingly, the claimed powder coating composition exhibits a stability upon storage which is defined as sufficient applying the parameters given in the present description. The stability upon storage may additionally be improved by adding anti-blocking additives such as, for example, amide waxes (for example Ceraflour 3910 or Ceraflour 6721).

Another aspect of stability upon storage is constituted by chemical pre-reactions (cross-linking reactions) which may even be observed at room temperature with strongly accelerated hybrid powder coatings. For the powder coating formulations of the invention, it has furthermore been shown that when using special catalysts which are sufficiently reactive, the stability upon storage of the powder coating is also guaranteed.

A further improvement in the stability upon storage may be obtained by temporarily storing the prepared powder coating or the powder coating granulate (extrudate which has not yet been ground) at a specific temperature (tempering). The storage temperature in this regard is in the range from 25° C. to 60° C., preferably in the range 30° C. to 45° C. The storage period is dependent on the storage temperature and is in the range from a few minutes at high temperatures to several days at low temperatures. Without wishing to be bound by a specific theory, it is assumed that by means of this storage (tempering), the re-crystallization of component C) which is at least partially melted during extrusion, is accelerated, whereupon the stability upon storage is further improved.

The claimed powder coatings are preferably produced as single-component powder coatings using the standard powder coating production process. The advantage of single-component powder coatings lies in the fact that they have a very homogeneous composition and are easier and cheaper to manufacture. However, it is also possible to produce a two-component powder coating with the claimed formulations. In the two-component powder coating, the composition of the individual components may vary. Different compositions of binders (resins), catalysts, hardeners, additives and fillers may be used in the individual components.

Component A:

The carboxy group-containing amorphous polyesters (component A) used in accordance with the invention have an acid value of 50 to 100 mg KOH/g and preferably a Tg of 35° C. to 80° C. The molar masses are preferably 2000 to 10000. As already discussed, the polyester resins in accordance with A) and C) contain a total of 15% to 75% by weight, preferably 15% to 60% by weight and particularly preferably 20% to 50% by weight, with respect to the monomers used for the synthesis, of linear and unbranched aliphatic diols or their derivatives and/or linear and unbranched aliphatic dicarboxylic acids or their derivatives.

When component A) is composed of a plurality of different amorphous polyesters, then, as given above, the arithmetic mean of the amorphous polyester must have an acid value of 50 to 100 mg KOH/g.

The polyesters containing carboxy groups employed may be produced by polycondensation of suitable dicarboxylic and/or polycarboxylic acids, esters and/or anhydrides and diols and/or polyols. As given in WO 2004/041904, the polycarboxylic acids preferably consist of 50 to 100 mol % terephtalic acid or isophthalic acid or mixtures thereof and up to 50 to 0 mol % of other aliphatic, cycloaliphatic or aromatic polycarboxylic acids. With respect to the polyol components, the amorphous polyesters preferably consist of 40 to 100 mol % neopentylglycol and 60 to 0 mol % of other aliphatic or cycloaliphatic polyols. Branched amorphous polyesters may also be used, which may be produced using appropriate polycarboxylic acids and/or polyols. Examples of polycarboxylic acids as well as polyols may be found in EP 1 426 423. Thus, examples of polycarboxylic acids are terephthalic, isophthalic, trimellitic, pyromellitic, tetrahydrophthalic, hexahydrophthalic, hexahydroterephthalic, succinic, adipic, suberic, azelaic, sebacic, phthalic, glutaric, di- and tetra-chlorophthalic, endomethylene tetrahydrophthalic, 1,4-cyclohexane dicarboxylic acid or their esters or anhydrides if obtainable. Examples of polyols are, as given in EP 1 426 423, monoethylene glycol, 1,2- and 1,3-propylene glycol, 1,4- and 2,3-butylene glycol, di-β-hydroxyethyl butanediol, 1,5-)entanediol, 1,6-hexanediol, 1,8-octanediol, decanediol, dodecanediol, neopentylglycol, cyclohexanediol, 3(4),8(9)-bis(hydroxymethyl)-tricyclo[5.2.1.0^{2,6}]decane (dicidol), bis-(1,4-hydroxymethyl) cyclohexane, 2,2-bis-(4-hydroxycyclohexyl) propane, 2,2-bis-[4-(β-hydroxyethoxy)phenyl] propane, 2-methyl-propane-1,3-diol, 2-methyl-pentane-1,5-diol, 2,2,4(2,4,4)- trimethylhexane-1,6-diol, glycerine, trimethylolpropane, trimethylolethane, hexane-1,2,6-triol, butane-1,2,4-triol, tris-(β-hydroxyethyl) isocyanurate, pentaerythritol, mannitol and sorbitol, as well as diethylene glycol, triethylene glycol, tetraethylene glycol, dipropylene glycol, polypropylene glycols, polybutylene glycols, xylylene glycol and hydroxypivalic acid neopentyl glycolester. Preferably, monoethylene glycol, neopentyl glycol, dicidol, cyclohexanedimethanol, trimethylolpropane and glycerine are used. These examples of suitable carboxylic acids and polyols may also be found in US 2004 0236037 AI. Amorphous polyester resins are frequently used components in the powder coating field and are known, inter alia, by the trade names Crylcoat (for example Crylcoat E 04187, Crylcoat E 38051, Crylcoat 1620-0, Crylcoat 1557-5, Crylcoat 1572-0, Crylcoat 1660-0, Crylcoat 1506-6, Crylcoat 1551-2, Crylcoat 1553-9), Uralac (for example Uralac P 5267, Uralac P 5170, Uralac P 3250, Uralac P 4260, Uralac P 4127, Uralac P 5127), Sirales (for example Sirales PE 8210, Sirales PE 8231, Sirales PE 8212) and Reafree (for example Reafree 6818, Reafree 6809, Reafree 6877).

Component B:

As the epoxy resins (component B), solid epoxy resins with an EEW of 350 to 650, preferably of 400 to 650 g/eq, are used. These resins preferably have a softening point of 70° C. to 120° C., in conformity with the manufacturer's specifications. It is also advantageous for 30% to 100% by weight of component B to consist of a hydrogenated epoxy resin. An embodiment of this type is advantageous because with it, the finished powder coating has a better UV resistance and better light fastness.

As an example, the epoxy resins described in WO 2001/092367 may be used; they are based on bisphenol A (“4-[2-(4-hydroxyphenyl)propan-2-yl]phenol”) and epichlorhydrin, in particular the diglycidylether of bisphenol A and higher addition products thereof. The epoxy resins may also consist of bisphenol F (“4,4′-methylene bisphenol”) as well as hydrogenated bisphenol A (“4,4′-isopropylidene dicyclohexanol”) and epichlorhydrin and higher addition products. Epoxy resins may also be used, which are produced by the reaction of epichlorhydrin with novolak resins. Novolak resins are produced by condensation of phenol compounds with formaldehyde in the presence of acid catalysts. Regarding the phenol compounds, these are either a phenol, or compounds such as cresols, xylenols, resorcinol, napthols and the like.

Examples of epoxy resins are commercially available with the names D.E.R. from Dow Chemical/Olin (for example D.E.R. 662E, D.E.R. 671), Araldite from Huntsman Advanced Materials (for example Araldite GT 6248, Araldite GT 7071, AraIdite GT 7072), Eposir from Sir Industriale (for example Eposir 7161, Eposir 7165, Eposir 7167 PG) or from Kukdo Chemical (for example YD-012, KD-211E, KD-211G, KD-242GHF). In a particular formulation of the invention, novolak-modified epoxy resins with an EEW of 350 to 650 g/eq are used such as, for example, Araldite GT 7220 (Huntsman), Araldite GT 6259 (Huntsman), D.E.R. 642U (Dow), KD-211D (Kukdo) or KD-211H (Kukdo). Combinations of epoxy resins may also be used, when the arithmetic mean of the epoxy equivalent weight must be in the range from 350 (preferably 400) to 650 g/eq. The EEW of the individual epoxy resins may thus also be <350 (400) g/eq or higher, >650 g/eq, as along as, when averaged over all of the epoxy hydrogens, the EEW is in the range from 350 (400) to 650 g/eq. As an example, novolak epoxy resins with EEW <400 g/eq (for example Araldite ECN 1299, Araldite GY280, D.E.N. 438, D.E.N. 439, Quatrex 1010 etc) may be added, as long as the averaged EEW of the epoxy resins used is not below 350 (400) g/eq. As an example, it is possible for the component B) to consist of 40% by weight AraWile ECN 1299 (EEW 217 to 244 g/eq) and 60% by weight D.E.R. 671 (EEW 475 to 550 g/eq). The averaged EEW here is 399.7 g/eq (0.4*230.5+0.6*512.5=399.7).

In a further aspect of the present invention, hydrogenated epoxy resins such as ST-5080 from Kukdo (EEW 550 to 650 g/eq) may be used alone or in combination with the epoxy resins mentioned above. By using hydrogenated epoxy resins, the UV resistance of the powder coating and thus the light fastness of the coating, can be substantially improved. One disadvantage, however, is the low reactivity of the hydrogenated epoxy resins. Thus, the hydrogenated epoxy resins are preferably used in combination with the novolak-modified epoxy resins in order to be able to maintain the baking conditions for heat-sensitive substrates.

Component C:

Crystalline or semi-crystalline polyester resins containing carboxy groups may be used as component C); they preferably have an arithmetically averaged acid value of 15 to 100 mg KOH/g. Furthermore, these polyester resins may preferably have a melting point or a melting range of 60° C. to 130° C. and also preferably have a viscosity of 0.1 to 10 Pa*s, preferably 0.1 to 1 Pa*s at 130° C., measured using the cone and plate method (Brookfield CAP 2000+). As already discussed, the polyester resins of A) and C) contain a total of 15% to 75% by weight, preferably 15% to 60% by weight and particularly preferably 20% to 50% by weight, with respect to the monomers used for the synthesis, of linear and unbranched aliphatic diols or their derivatives and/or linear and unbranched aliphatic dicarboxylic acids or their derivatives. In a preferred embodiment, these polyesters also have a melting enthalpy of 50-150 J/g. Even more preferably, the polyester resins of C) have an aromatics content of less than 50 mol %, preferably less than 20 mol %, and particularly preferably less than 15 mol %, respectively with respect to the monomers used. Surprisingly, it has been observed that with a higher content of aromatics in the composition, the flexibility of the powder coating produced has a tendency to reduce. (Semi)crystalline or crystalline polyesters may be used which are constructed from components such as those which are given in DE 1020 06057837 A1. The polyesters C) are based on polycarboxylic acids and polyols, wherein the polycarboxylic acids employed are preferably linear, aliphatic dicarboxylic acids containing 2 to 22 methylene groups and/or terephthalic acid/isophthalic acid. The polyols employed may, inter alia, be (cyclo)aliphatic alcohols containing 2 to 10 C atoms. The aromatics content of component C) should preferably by less than 50 mol %, particularly preferably less than 20 mol % and more particularly preferably less than 15 mol %, with respect to the monomers used for the resin synthesis. Preferably, (semi)crystalline or crystalline polyester resins are used which contain, as the polycarboxylic acid, mainly succinic acid and/or its anhydrides or derivatives, and as the polyol, 1,4-butanediol—preferably primarily. In this regard, particularly advantageously, the polyol of the polyester resin of C) is used in an amount of more than 50 mol %, preferably more than 75 mol % and particularly preferably more than 90 mol % 1,4-butanediol, and as the polycarboxylic acid, more than 50 mol %, preferably more than 75 mol % and particularly preferably more than 90 mol % succinic acid and/or its anhydrides and/or its derivatives. More advantageously, the polyester resin of C) does not contain any organotin components.

Component D:

The catalysts for accelerating the reaction between carboxy groups and epoxy groups as well as for epoxy homopolymerization which may be used may, for example, be those compounds which are given in WO 2001/092367 A1, as long as when they are used, the gel times mentioned below for the powder coating which is produced are complied with.

Preferably, the catalysts are used in this case in a quantity of 0.5% to 6% by weight, particularly preferably 0.8% to 4% by weight, most preferably in a quantity of 1.0% to 3.0% by weight (respectively with respect to the total formulations). The inventive concentrations given for the catalyst or for component D are always with respect to the active substance.

In accordance with a preferred embodiment of the present invention, the powder coating composition contains 0.1% to 3.0% by weight (with respect to the total formulations) of imidazoles as the catalysts (component D).

Examples of particularly suitable catalysts are imidazoles (such as, for example, “2-methyl imidazole”, “2-ethyl imidazole”, “propylimidazole”, “2-isopropyl imidazole”, “2-phenyl imidazole”, “2-undecylimidazole”, “2-heptadecyl imidazole”, “1-((2-methyl-1H-imidazol-1-yl)methyl)naphthalen-2-ol”), imidazoline (such as, for example, “2-phenyl-2-imidazoline”), tertiary amines (such as, for example, “2,4,6-tri-(dimethylaminomethyl)phenol”, “N,N-dimethyl-stearylamine”), phosphonium salts (such as, for example, “tetrabutylphosphonium bromide”, “butyltriphenyl-phosphonium chloride”, “butyltriphenyl phosphonium bromide”, “ethyltriphenyl phosphonium bromide”, ammonium compounds (such as, for example, “benzyltrimethyl ammonium bromide”, “tetraethylammonium-benzoate”, “choline chloride”), urons (such as, for example, “fenuron”, “diuron”, “chlortoluron”, “TDI-urons”), guanidines (such as, for example, “ortho-tolyl biguanide”) and/or zinc compounds (such as, for example, “zinc acetyl acetonate”, “zinc 2-ethylhexyl phosphate salt”). Catalysts may also be used in the form of adducts (such as, for example, imidazole adducts, imidazoline adducts). The catalysts (such as, for example, imidazoles, imidazolines, phosphonium salts) may be added to the polyester resins as early as during the resin synthesis.

Preferably, 2-phenyl-2-imidazoline (for example “Eutomer B31” from Eutec Chemical Co.) is used as the catalyst, preferably in a concentration of 0.3% to 2.0% by weight with respect to the total formulation. However, combinations of this catalyst with one or more of the aforementioned catalysts, preferably with imidazoles (such as 2-ethyl imidazole, for example) or phosphonium salts (such as ethyltriphenyl phosphonium bromide, for example) may be used in order to obtain the highly reactive and powder coating which is simultaneously stable upon storage in accordance with the invention. By means of combinations of these types of accelerators, more stable systems may be obtained if necessary which have an enhanced stability upon storage when variations in homogeneity occur during powder coating production. With combinations of catalysts, the individual catalysts may also he below the preferred range of 0.5% by weight (with respect to the total formulation). In this connection, advantageously, phosphonium salts and/or ammonium salts are present as the catalysts (component D) in a quantity of 0.1% to 1.0% by weight with respect to the total formulation, particularly preferably ethyl-triphenyl phosphonium bromide.

During the course of tests which led to the present invention, a series of catalysts were investigated as to their usefulness together with the components A, B, C and F. of the binder combination in accordance with the invention in order to produce a powder coating. In this regard, the preferred quantities of the catalysts were as follows:

TABLE 1
Catalysts for the curing reaction

| | | | Preferred | |
|---|---|---|---|---|
| | | | range [% by | |
| | | | weight with | |
| | | | respect | |
| | | | to total | |
| | | | formulation[ | |
| Group | | MW | Min | Max |
| Imidazoline | 2-phenyl-2-imidazoline | 146.19 | 1.0 | 2.0 |
| Imidazole | 2-ethyl imidazole | 96.13 | 1.0 | 2.0 |
| | 2-propyl imidazole | 110.16 | 2.0 | 3.5 |
| | 2-phenyl imidazole | 144.17 | 3.0 | 4.0 |
| | 2-undecyl imidazole | 222.37 | 4.0 | 5.0 |
| | 2-heptadecyl imidazole | 306.53 | 5.0 | 6.0 |
| | 1-((2-methyl-1H-imidazol-1-yl)- | 238.28 | 4.0 | 6.0 |
| | methyl)naphthalen-2-ol | | | |
| Quaternary | Ethyltriphenyl phosphonium | 371.25 | 0.8 | 1.5 |
| phosphonium | bromide | | | |
| salts | Butyltriphenyl phosphonium | 399.3 | 0.8 | 1.5 |
| | chloride | | | |
| Tertiary | 2,4,6-tri- | 265.39 | 2.5 | 3.5 |
| amines | (dimethylaminomethyl)- | | | |
| | phenol | | | |
| | Stearyl dimethylamine | 297.56 | 4.0 | 6.0 |
| Ammonium | Choline chloride | 139.62 | 3.0 | 5.0 |
| salts | Benzyl trimethylammonium | 230.14 | 1.0 | 3.0 |
| | bromide | | | |
| | Tetraethylammonium benzoate | 251.36 | 0.8 | 2.5 |
| | Triphenylphosphine | 262.28 | 0.8 | 2.5 |

Furthermore, it has surprisingly been shown that it is particularly advantageous for the binder composition including the catalysts in accordance with D) to contain no organotin components.

Component E:

As additional hardeners (cross-linkers), if appropriate, compounds may be used which have a functionality of ≥2 and, for example, contain epoxy, carboxy, anhydride, amine, amide, hydroxy and/or phenol groups. In a particular embodiment of the powder coating in accordance with the invention, surprisingly, it has been observed that during the optional addition of an additional highly reactive hardener (cross-linker) such as, for example, polyamines, smooth low temperature powder coatings with gloss levels in the range from 20 to 50 gloss units (measuring angle)60° can be produced.

By means of these polyamines and polyamine adducts such as, for example, Aradur 835 (Huntsman Advanced Materials), Ancamine 2014AS/FG (Air Products) and Ancamine 2441 (Air Products), an additional cross-linking reaction occurs with the powder coating binder, in particular with the epoxy resin it contains. Without wishing to be bound by a particular theory, it is assumed that the mattification effect is based on the fact that different curing reactions are running with different reactivities. It is assumed that, even at lower temperatures, the amine groups rather than the carboxy groups (of the polyester resins) react with the epoxy groups and/or have a higher reaction rate. By means of these different curing reactions, presumably a roughness is built up on the powder coated surface. This roughness, which results in breaking up the light and thus to a mattification effect, is sufficiently small, however, to produce a smooth surface on conventional industrial scales.

It is also advantageous for the powder coating in accordance with the invention to contain an appropriate quantity of one or more catalysts (accelerators) for the cross-linking reaction(s) in order to provide a gel time of 50 to 240 sec at 130° C., preferably 70 to 200 sec at 130° C. and particularly preferably 90 to 160 sec at 130° C., wherein the gel time measurement is carried out in conformity with ÖNORN EN ISO 8130-6 and the time measurement is started immediately after transferring the powder coating test portion to the depression in the heated block. In the given gel time gel time ranges, the reactivity of the powder coating of the invention is optimized in order to obtain a good surface on the one hand and good curing on the other hand.

In a further particular embodiment of the powder coating in accordance with the invention, it was surprisingly discovered that adding amine compounds such as polyamines, for example, can result in a substantial improvement in the stability upon storage of the powder coating.

In a more specific formulation of this invention, the powder coating may contain more additional or alternative mattification agents. With textured surfaces, mattification is usually accomplished by adding texturizing agents example micronized Teflon or micronized PTFE-wax blends). However, mattification may also be carried out using fillers, waxes, acrylate resins or the methods with highly reactive hardeners (for example polyamines) described above.

Further components of the powder coating formulation may be constituted by additives, pigments and filters which are known in the prior art. Without claiming to be a complete list, the additives which may be used are levelling agents, anti-crater additives, texturizing agents, degassing agents, antioxidants, UV absorbers, (tribo-)charge control substances, anti-blocking additives (for example waxes to improve the stability upon storage), fluidization agents, flame retardants, IR absorbers and additives for improving the surface properties (such as, for example, hardness, abrasion resistance, scratch resistance, chemical resistance, over-painting capability, adhesion, surface tension, and substrate wetting).

In a particular embodiment, the components C) and/or D) may be pre-distributed by mixing and extrusion with one or more of the binders. The granulate from this extrusion is then used for the production of the complete batch of powder coating. By means of this so-called melt mixing, powder coating properties such as, for example, reactivity and stability upon storage, may be improved. In addition, improvements for the powder coating production process may be obtained.

The advantages of the powder coating formulations in accordance with the invention can be summarized as follows:

1. A highly reactive powder coating is provided which can be baked for 3 min to 5 min at 130° C. to 150° C. (substrate surface temperature) and thus delivers a coating which is highly deformable and has good surface properties. The powder coatings provided in accordance with the invention are particularly suitable for single layer topcoat applications to wood substrates in which substantial deformations may occur because of dimensional variations. The powder coating in accordance with the invention can be stable upon storage for several months at room temperature.

2. The powder coatings described above are suitable for the formation of a smooth surface with a low gloss level of 20 to 50 gloss units at a measuring angle of 60°.

3. The powder coatings described above have an additionally improved UV resistance and light fastness because of the use of hydrogenated epoxy resins.

Surprisingly, it has been shown that the powder coating composition in accordance with the invention may be used for coating substrates, in particular for coating temperature-sensitive substrates formed from plastics and wood materials such as, for example LDF, MDF, HDF, particle board, OSB, BOF (board of frame), plywood, thereto wood, solid wood and WPC) as a single layer topcoat or after prior coating with a base coat. Until now, epoxy-polyester hybrid powder coatings could only be applied as two-coat systems in order to comply with the demands placed on these substrates (for example deformability and resistance in the water swelling test). The powder coatings in accordance with the present invention enable a single coat application to be used for the first time.

Advantageously again, the powder coating composition in accordance with the invention is used for coating substrates and subsequent over-painting with a powder coating and/or liquid coating and/or other coating agent such as toners and tints.

Finally, it is also advantageous for the powder coating composition in accordance with the invention to be used for coating wood or wood-based substrates such as LDF, MDF, HDF, particle board OSB, BOF (board of frame), plywood, thereto wood, solid wood and WPC.

### EXAMPLES

Powder coatings in accordance with the invention were produced using e components given further below, as follows.

The individual components were weighed, mixed with a Thermo Prism Pilot-3 laboratory mixer and then the powder coating batch was extruded on a Theysohn TSK 20/24 twin screw extruder at 400 min⁻¹ and at a torque of 50-80%. The temperature in the last two zones of the extruder was set at 80° C.

The extruded material was comminuted to form a granulate and then milled on an ACM-2L impact classifier mill from Hosokawa Alpine. The powder coatings in accordance with the invention which were produced had a mean particle size (d50) of 25-50 μm.

In order to test the reactivity of the powder coatings, the gel time was measured in conformity with ISO 8130-6. The gel time measurements were carried out at a temperature for the heated block of 130° C. In contrast to that stated in the standard, the time measurement was started immediately after transferring the powder coating sample quantity into the depression in the heated block and not after the whole of the powder had been completely melted.

With the powder coatings in accordance with the invention, aluminium sheets (0.7 mm thickness) were coated by electrostatic powder application and baked for 5 min at 160° C. In a convection oven (electric convection oven, Heraeus UT 12). Standard powder coating tests such as layer thickness in accordance with ISO 2360, gloss level in accordance with ISO 2813, Erichsen cupping test in accordance with ISO 1520 and mandrel bending test in accordance with ISO 1519 were carried out.

The powder coatings in accordance with the invention were also applied to MDF boards by means of electrostatic application and then cured in a gas catalytic infrared oven from Vulcan Catalytics. The types of MDF used were “MB” and “MBP-L” from Egger with board thicknesses of 19 mm and 25 mm, and 18 mm MDF boards from Sonae. The baking process in the infrared oven consisted of a heating phase of 60 to 120 sec, in which the powder-coated MDF was brought to the curing temperature of 130° C. to 150° C. Next, the oven settings were adjusted so that during the 3 min to 5 min cure period, the substrate surface temperature remained constant in the range from 130° C. to 150° C.

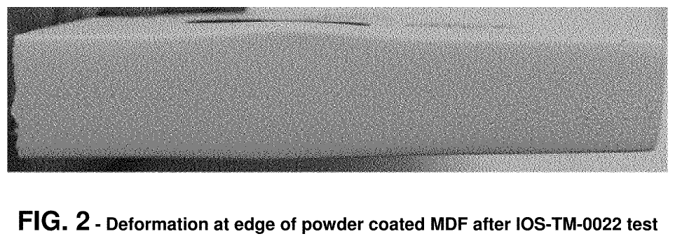

The MDF boards coated with the powder coatings in accordance with the invention were above all used to assess the crack resistance at the edges in conformity with the IKEA test standard IOS-TM-0022. In this test, a hinge hole with a diameter of 35 mm was drilled at a distance of 5 mm from the edge, 13 mm deep (for 18 mm thick MDF), 14 mm deep (for 19 mm thick MDF) or 20 mm deep (for 25 mm thick MDF). This hole was then filled with distilled water and stored at room temperature (20±2° C.) for the duration of the test. Preferably, the tests were carried out at room temperature in order to simulate loading at actual service temperatures (for example of furniture parts) and not as given in the test standard, i.e. at approximately 6° C. The assessment of the cracking resistance was carried out by means of the time which passed until cracking occurred at the edge or even in the region of the hinge hole (FIG. 2). In this regard, advantageously, with an at least 80 _{K}m thick coating on 19 mm thick MDF boards the water swelling test in conformity with IKEA test standard IOS-TM-0022 was passed for more than 12 hours without cracking, preferably for 24 hours without cracking. Satisfying these requirements meant that a good to very good long term crack resistance for coated wood materials could be obtained.

The Gloss level (60° MA) of the MDF samples coated with the powder coatings in accordance with the invention was also determined at a measuring angle of 60° and the curing was determined by means of the chemical resistance with acetone or methyl ethyl ketone (MEK). A sufficient cross-linking is given when, with the test in accordance with EN 12720 with acetone (or MEK) over a test period of 10 sec, an assessment (in accordance with EN 12720) of at least 2 was obtained. The adhesion between powder coating and MDF was tested by means of the cross cutting test in accordance with ISO 2409. For a sufficient adhesion, the cross cutting test value must be GtO or Gt1. This was obtained for the examples listed below corresponding to the powder coating in accordance with the invention.

The viscosity measurements for the resins in the context of this invention was made using a Brookfield CAP 2000+ measuring instrument using the cone & plate method with a spindle (cone) which, according to the manufacturer, is suitable for the relevant viscosity range.

In the context of the present invention, the term “aliphatics content”, unless specifically stated otherwise, should be understood to mean the total content of linear aliphatic dicarboxylic acids and linear aliphatic diols in the components A) and C) with respect to the monomers used for the synthesis of components A) and C).

In the case of aliphatics contents given for individual resins, these are with respect to the monomers used in the synthesis of these resins.

### Examples A1-A6

Examples A1 to A6 were used to investigate which amorphous polyesters and which epoxy resins could be used for the highly reactive powder coatings in accordance with the invention.

The amorphous polyesters had the following acid values. “Polyester 1” was a carboxy polyester with an acid value of 68 to 76 mg KOH/g and a viscosity of 2.0 to 3.5 Pa*s (measured at 200° C. with a Brookfield CAP 2000+ using the cone & plate method), which consisted of the essential components terephthalic acid, adipic acid, neopentyl glycol, monoethylene glycol and trimellitic acid anhydride and was produced by melt polymerization at a temperature of up to 240° C.

“Crylcoat 1783-0” has an acid value of 30 to 38 mg KOH/g and a viscosity of 4.2 to 5.8 Pa*s (Brookfield Viscosity (a) 200° C.). Crycloat 1626-0 has an acid value of 44-52 mg KOH/g and a viscosity of 2 to 4 Pa*s (Brookfield Viscosity @ 200° C.). Crycloat 1660-0 has an acid value of 45 to 51 mg KOH/g and a viscosity of 6.8 to 10.2 Pa*s (Brookfield Viscosity @ 175° C.),

D.E.R. 692 is an epoxy resin with an EEW of 660 to 720 g/eq and Araldite GT 7004 is an epoxy resin with 714 to 752 g/eq.

TABLE 2
Examples A1) to A6) with different amorphous
polyester resins and different epoxy resins

| Component | A1 | A2 | A3 | A4 | A5 | A6 |
|---|---|---|---|---|---|---|
| Polyester 1 | 28.7 | | | 28.7 | 28.7 | |
| Crylcoat 1783-0 | | 46 | | | | |
| Crylcoat 1626-0 | | | 40 | | | |
| Crylcoat 1660-0 | | | | | | 33.4 |
| Polyester 7 | 9 | 9 | 9 | 9 | 9 | 10 |
| Araldite GT 7220 | 22.3 | 17.8 | 21 | | | |
| D.E.R. 692H | | | | 29 | | 23.7 |
| ARALDITE GT 7004 | | | | | 30.8 | |
| Polyester 2 | 2.5 | 2.5 | 2.5 | 2.5 | 2.5 | 2.5 |
| Eutomer B31 | 1 | 1 | 1 | 1 | 1 | 1 |
| LANCO WAX TF 1778 | 1 | 1 | 1 | 1 | 1 | 1 |
| BYK 3900 P | 1 | 1 | 1 | 1 | 1 | 1 |
| PORTAFILL A 40 | 20 | 7.2 | 10 | 13.3 | 11.5 | 12.9 |
| Tioxide TR81 | 14.5 | 14.5 | 14.5 | 14.5 | 14.5 | 14.5 |

TABLE 3
Test results for Examples A1) to A6)

| Tests | A1 | A2 | A3 | A4 | A5 | A6 |
|---|---|---|---|---|---|---|
| Gel time at 130° C. [sec] | 159 | 299 | 266 | 265 | 262 | 299 |

It can be seen from Examples A1 to A6 that only Example A1, with a gel time of 159 seconds (measured at 130° C.), exhibited a sufficient reactivity. The other examples with amorphous polyester resins with acid values of less than 50 KOH/g and with epoxy resins with an EEW of more than 650 g/eq have too little reactivity and could not be cured under the described baking conditions.

### Examples 1) to 12

In the examples below, powder coatings are do bed which satisfy the requirements for reactivity, deformability and stability upon storage.

The powder coatings consisted of the following components:

Polyester 1 has already been described in the above Examples A1) to A6). Araldite GT 7220 (from Huntsman) is an epoxy resin based on bisphenol A and phenol novolak with an EEW of 518 to 546 g/eq. Polyester 7 is a (semi)crystalline polyester resin, produced from succinic acid and 1,4-butane diol, with an acid value of 28 to 36 mg KOH/g, a viscosity of 0.1 to 0.2 Pa*s (measured at 130° C. with Brookfield CAP 2000+ using the cone & plate measurement method) and a melting point of 120.4° C. (measured using DSC, melting peak maximum with a heating rate of 20 K/min).

Eutomer B31 (from Eutec Chemical Co.) is a 2-phenyl-2-imidazolim catalyst.

Polyester 2 is an OH-functional polyester which contains approximately 10% by weight of ethyltriphenyl phosphonium bromide. The OH number of polyester 2 is in the range from 39 to 49 mg KOH/g and the viscosity is 1.0 to 2.5 Pa*s (at 200° C., Cone & Plate, Brookfield CAP 2000+). Polyester 2 essentially consists of the components terephthalic acid, neopentyl glycol, monoethylene glycol and isophthalic acid, was produced by melt polymerization at a temperature of up to 240° C. and then supplemented with approximately 10% of ethyltriphenyl phosphonium bromide.

Reafree C4705-10 (Arkema) is a catalyst masterbatch based on a COOH-functional polyester with an acid value of 30 to 40 mg KOH/g, which contains approximately 10% by weight of ethyltriphenyl phosphonium bromide.

Modaflow P6000 and BYK-3900P were added as anti-crater agents and levelling agents.

Deuteron AP 348 and Carbocure 8000 ( from Lubrizol) were preferably added as mattification waxes.

Ceridust 6721 is a polypropylene/amide wax, which is preferably added because of its “anti-blocking” properties in order to improve the stability upon storage of the powder coating.

Lanco TF 1778 was added in order to improve he surface properties, in particular the scratch resistance.

TABLE 4
Examples 1 to 6 - Powder coatings with smooth surfaces

| Component | Example 1 | Example 2 | Example 3 | Example 4 | Example 5 | Example 6 |
|---|---|---|---|---|---|---|
| Polyester 1 | 31.7 | 31.7 | 26.5 | 28.7 | 32.7 | 32.6 |
| Araldite GT 7220 | 24.3 | 24.3 | 21 | 22.3 | 25.5 | 25.9 |
| Polyester 7 | 9 | 9 | 9 | 9 | 10 | 12 |
| Eutomer B31 | 1 | 1 | | 1 | 1 | 1.5 |
| 2-ethyl imidazole | | | 1 | | | |
| Polyester 2 | 2 | | | 2.5 | 2.5 | |
| Reafree C4705-10 | | 2 | | | | |
| Modaflow P6000 | | | | | | 1 |
| BYK 3900 P | 1 | 1 | 1 | 1 | | |
| Deuteron AP 348 | | | | | | 2 |
| Carbocure 8000 | | | | | 5 | |
| Ceridust 6721 | | | | | 2 | |
| Lanco TF 1778 | 1 | 1 | 1 | 1 | 1 | |
| Ti-Select 6200 | | | | | | 25 |
| Tioxide TR81 | 16 | 16 | 20.5 | 14.5 | 20.3 | |
| Portafill A 40 | 14 | 14 | 20 | 20 | | |

TABLE 5
Test values for Examples 1 to 6

| | | | | | |
|---|---|---|---|---|---|
| Example 1 | Example 2 | Example 3 | Example 4 | Example 5 | Example 6 |

Tests

| | | | | | | |
|---|---|---|---|---|---|---|
| Gel time at 130° C. [sec] | 140 | 134 | 152 | 159 | 180 | 154 |

Aluminium sheet (5 min 160° C.)

| | | | | | | |
|---|---|---|---|---|---|---|
| Coat thickness [μm] | 49 | 65 | 60 | 75 | 75 | 80 |
| Gloss level (60° MA) | 70 | 69 | 59 | 59 | 69 | 66 |
| Erichsen cupping [mm] | 3.8 | 4.2 | 2.9 | 4.3 | 7 | 7.2 |
| Mandrel bending test [mm] | 7.1 | 7.1-8.9 | 17.4 | n.k. | n.k. | n.k. |
| | | | | (not known) | | |

MDF sample (3 min 150° C.)

| | | | | | | |
|---|---|---|---|---|---|---|
| Coat thickness [μm] | 100-160 | 180 | 130-240 | 120 | 70-80 | 130 |
| Gloss level (60° MA) | 68-71 | 71 | 55 | 61 | 56-61 | 63 |
| Water swelling test at room | No | No | No | No | No | No |
| temperature (25° C. in | cracking | cracking | cracking | cracking | cracking | cracking |
| conformity with IOS-TM-0022) | after 48 h | after 48 h | after 48 h | after 24 h | after 48 h | after 48 h |

Stability upon storage - after storage at 30° C.

| | | | | | | |
|---|---|---|---|---|---|---|
| Gel time (130° C.) after 14 | 78 | 73 | 82 | 90 | 105 | n.k. |
| days [sec] | | | | | | |
| Gel time (130° C.) after 30 | n.k. | n.k. | n.k. | 80 | 98 | n.k. |
| days [sec] | | | | | | |

### Examples 1) and 2)

In these examples, a combination of two accelerators was used.

In Example 1), a gel time (at 130° C.) of 140 seconds was measured; in Example 2), it was 134 seconds. Both powder coatings, upon curing for 3 min at 150° C. on MDF, delivered a very good deformability. The deformability test on MDF, in conformity with IOS-TM-0022, was passed at room temperature (25° C.) for 48 hours without cracking. The stability upon storage of the two powder coatings was classified as sufficient. After storage for 14 days at 30° C., the gel time of Example 1) had reduced to 78 seconds (reduction of 44.3%); in Example 2), it was 73 seconds (reduction of 41.5%).

### Example 3)

In Example 3), only 2-ethyl imidazole was used as the catalyst. The reactivity was very high, with a gel time (measured at 130° C.) of 152 seconds, wherein after storage for 14 days (at 30° C.), the gel time reduced by approximately 50%. The stability upon storage could thus be assessed as sufficient. In Example 3), a mattification to a gloss level of 55 (60° MA) was obtained because of the large proportion of filler (Portafill A 40). Because of the smaller proportion of binder, the Erichsen cupping was only 2.9 mm. However, the deformability on MDF was very good and the IOS-TM-0022 test at room temperature for 48 hours was passed without cracking.

### Example 4)

In Example 4), the same combination of catalysts was used as in Example 1). A mattification occurred due to the high proportion of Portafill A 40. The reduction in the gel time after storage for 14 days at 30° C. reached approximately 43% (gel time at 130° C. reduced to 90 sec). after 30 days at 30° C., the gel time had reduced to 80 sec, which corresponded to a reduction of approximately 50%. The stability upon storage could be assessed as sufficient to good.

A gloss level of 61 (at)60° was measured on the MDF sample for a layer thickness of 120 μm. The IOS-TM-0022 test was passed for 24 hours without cracking, corresponding to a good deformability. The chemical resistance was assessed to have the value 2 (in accordance with EN 12720) with 10 seconds of MEK.

### Example 5)

In Example 5), mattification was carried out by means of the additive “Carbocure 8000” to a gloss level of 69 (60° MW) on aluminium sheet and 56-61 (60° MW) on the MDF sample. The gel time (130° C.) was measured at 180 seconds and the powder coating passed the IOS-TM-0022 test for 48 hours without cracking. The gel time reduced to approximately 105 seconds after 14 days at 30° C. (reduction of approximately 42%) and to 98 seconds after 30 days at 30° C. (reduction of approximately 46%). The stability upon storage could be assessed as good.

### Example 6)

In Example 6), only 2-penyl-2-imidazoline was used as the catalyst. The deformability (test on edge cracking) was carried out in accordance with the IKEA test method IOS-TM-0022, wherein the storage was undertaken at room temperature (approximately 25° C.). The without edge cracking test was passed after 48 hours swelling time. The chemical resistance of the coating film was tested using acetone in accordance with EN 12720. For a test time of 10 seconds, an assessment of 2 (in accordance with EN 12720) was obtained with acetone. The surface of the baked powder coating from Example 6) was smooth with negligible orange skin effect. The gloss level was in the range 63-66 gloss units (at a measuring angle of)60° with the aluminium sheet and the MDF sample.

### Examples 7) and 8)

In Example 7) and Example 8), a smooth surface with a low gloss level was obtained by adding a polyamine. The epoxy resin used was D.E.R. 642U from Dow Chemicals, which had an EEW of 52.0-560 g/eq. Aradur 835 (from Huntsman) was used as the component E); it was an aliphatic polyamine adduct with an amine number of 180-210 mg KOH/g. Adding the Aradur 835 mattified the powder coating. -phenyl-2-imidazoline (Eutomer B31) was used as the catalyst.

TABLE 6
Examples 7 and 8 - Powder coating with smooth surface

| Component | Example 7 | Example 8 |
|---|---|---|
| Polyester 1 | 27.8 | 22.4 |
| D.E.R. 642U | 29.5 | 27.6 |
| Polyester 7 | 10 | 10 |
| Eutomer B31 | 1.2 | 1 |
| Aradur 835 | 4.1 | 5 |
| Modaflow P6000 | 1 | |
| BYK 3900 | | 1 |
| Lanco TF 1778 | 0.8 | 1 |
| Pigments | 0.06 | |
| Ti-Select 6200 | 22.4 | |
| Tioxide TR 81 | | 15 |
| Portafill A 40 | | 17 |
| Omyacarb 1-SV | 3.14 | |

TABLE 7
Test results for Examples 7 and 8

| Tests | Example 7 | Example 8 |
|---|---|---|
| Gel time at 130° C. [sec] | 190 | 166 |

Aluminium sheet (5 min 160° C.)

| | | |
|---|---|---|
| Coat thickness [μm] | 98 | 85 |
| Gloss level (60° MA) | 48 | 23 |
| Erichsen cupping [mm] | n.k. | 4.4 |

MDF sample (3 min 150° C.)

| | | |
|---|---|---|
| Coat thickness [μm] | n.k. | 240 |
| Gloss level (60° MA) | n.k. | 23 |
| Water swelling test at room temperature | n.k. | No cracking after |
| (25° C. in conformity with IOS-TM-0022) | | 8 h |

Stability upon storage - after storage at 30° C.

| | | |
|---|---|---|
| Gel time (130° C.) after 14 days [sec] | n.k. | 150 |

In Example 7), a smooth surface with a gloss level of 48 (60° MW) was obtained on aluminium sheet. In Example 8), the gloss level could be reduced to 23 (60° MW).

### Examples 9) to 12)

In Examples 9) to 12), combinations of epoxy resins were used. The formulations respectively contained “Araldite ECIC 1299”, which has an EEW of 217-244 g/eq, and respectively a further epoxy resin. D.E.R. 671 has an EEW of 475-550 g/eq, D.E.R. 662E has an EEW of 590-630 g/eq and D.E.R. 692 has an EEW of 660-720 g/eq.

TABLE 8
Examples with combinations of epoxy resins

| | | Example | Example | Example |
|---|---|---|---|---|
| Component | Example 9 | 10 | 11 | 12 |
| Polyester 1 | 36.90 | 36.70 | 35.80 | 35.00 |
| Polyester 7 | 10.00 | 10.00 | 10.00 | 10.00 |
| Araldite ECN 1299 | 7.50 | 7.50 | 7.50 | 7.50 |
| D.E.R. 671 | 10.60 | | | |
| D.E.R. 642U | | 10.80 | | |
| D.E.R. 662E | | | 11.70 | |
| D.E.R. 692 | | | | 12.50 |
| Eutomer B31 | 1.00 | 1.00 | 1.00 | 1.00 |
| LANCO WAX TF 1778 | 1.00 | 1.00 | 1.00 | 1.00 |
| BYK 3900 P | 1.00 | 1.00 | 1.00 | 1.00 |
| Tioxide TR81 | 32.00 | 32.00 | 32.00 | 32.00 |

In Examples 9) to 12), the reactivity requirements were satisfied. The stability upon storage in Examples 9), 11) and 12) was good. Example 10), which exhibited a very low gel time of 127 seconds, exhibited a reduction of approximately 50% in the gel time. The deformability was tested in Examples 9), 10) and 11) with the aid of the IOS-TM-0022 test on MDF and was assessed to be good to very good.

TABLE 9
Test results for Examples 9 to 12

| Tests | Example 9 | Example 10 | Example 11 | Example 12 |
|---|---|---|---|---|
| Gel time at 130° C. [sec] | 141 | 127 | 152 | 157 |

Aluminium sheet (5 min 160° C.)

| | | | | |
|---|---|---|---|---|
| Coat thickness [μm] | 70 | 95 | 115 | 85 |
| Gloss level (60° MA) | 82.9 | 90 | 90 | 89 |
| Erichsen cupping | 4.4 | 6.1 | 6.6 | 6.5 |
| [mm] | | | | |

MDF sample (3 min 150° C.)

| | | | | |
|---|---|---|---|---|
| Coat thickness [μm] | 90-130 | 85-140 | 65-90 | n.k. |
| Gloss level (60° MA) | 69-72 | 79-80 | 54-55 | n.k. |
| Water swelling test at room | No cracking | No cracking | No cracking | n.k. |
| temperature (25° C. in conformity with | after 48 h | after 48 h | after 8 h | |
| IOS-TM-0022) | | | | |

Stability upon storage - after storage at 30° C.

| | | | | |
|---|---|---|---|---|
| Gel time (130° C.) after 14 days [sec] | 71 | 64 | 92 | 93 |

### Examples 13) to 19)

In Examples 13) to 19), different polyester resins were tested as components A) and C). These polyesters differed in their composition and had varying contents of linear, aliphatic dicarboxylic acids and linear, aliphatic diols. The total content of linear aliphatic dicarboxylic acids and linear aliphatic diols in the components A) and C) with respect to the monomers used for the synthesis of components A) and C) will be described below as the aliphatics content.

Polyester 1, which consisted of 7.02% aliphatics, and polyester 3, which had an aliphatics content of 1.1%, were tested as component A). Polyester 3 is produced in a similar manner to polyester 1, but with isophthalic acid instead of trimellitic acid anhydride and terephthalic acid. The acid value of polyester 3 was 50-55 mg KOH/g and the viscosity was 3.0 to 4.5 Pa*s (measured at 200° C. with Brookfield CAP 2000+using the cone & plate measurement method).

The (semi)crystalline polyester 4, polyester 5, polyester 6 and polyester 7 were tested as component C).

Polyester 4 was produced from succinic acid, terephthalic acid, adipic acid and 1,6-hexanediol and had an aliphatics content of 66.4% by weight. Polyester 4 had an acid value of 27.5 mg KOH/g, a viscosity of 1.6 to 3.5 Pa*s (measured at 160° C. with Brookfield CAP 2000+ using the cone & plate measurement method) and a melting point of 89.9° C. (measured using DSC, melting peak maximum with a heating rate of 20 K/min).

Polyester 5 was produced from succinic acid, 1,4-butanediol and terephthalic acid and had an aliphatics content of 88.1% by weight. Polyester 5 had an acid value of 67.6 mg KOH/g, a viscosity of 0.1 to 0.27 Pa*s (measured at 130° C. with Brookfield CAP 2000+ using the cone & plate measurement method) and a melting point of 97.3° C. (measured using DSC, melting peak maximum with a heating rate of 20 K/min).

Polyester 6 was produced from dodecanoic acid, 1,4-butanediol and trimellitic acid anhydride and had an aliphatics content of 89.1% by weight. Polyester 6 had an acid value of 75.4 mg KOH/g, a viscosity of 0.29 Pa*s (measured at 160° C. with Brookfield CAP 2000+ using the cone & plate measurement method) and a melting point of 69.9° C. (measured using DSC, melting peak maximum with a heating rate of 20 K/min).

Polyester 7 was produced from succinic acid and 1,4-butanediol and had an aliphatics content of 100% by weight. Polyester 7 had an acid value of 28 to 36 mg KOH/g, a viscosity of 0.1 to 0.2 Pa*s (measured at 130° C. with Brookfield CAP 2000+ using the cone & plate measurement method) and a melting point of 120.4° C. (measured using DSC, melting peak maximum with a heating rate of 20 K/min).

Polyester 8 was produced from terephthalic acid, adipic acid and 1,6-hexanediol and had an aliphatics content of 48.5% by weight. Polyester 8 had an acid value of 29.1 mg KOH/g, a viscosity of 3 to 4.5 Pa*s (measured at 160° C. with Brookfield CAP 2000+ using the cone & plate measurement method) and a melting point of 126.1° C. (measured using DSC, melting peak maximum with a heating rate of 20 K/min).

TABLE 10
Examples 13) to 19)

| Component | Example 13 | Example 14 | Example 15 | Example 16 | Example 17 | Example 18 | Example 19 |
|---|---|---|---|---|---|---|---|
| Polyester 1 | 33.8 | 33.8 | 32.2 | | | 32.9 | 30.5 |
| Polyester 3 | | | | 35.4 | 34.6 | | |
| D.E.R. 642U | 24.7 | 24.7 | 26.3 | 21.6 | 21.4 | 24.6 | 26 |
| Polyester 4 | | 6 | | | | | |
| Polyester 5 | | | | | | | 8 |
| Polyester 6 | | | 6 | | | | |
| Polyester 7 | | | | 9 | 10 | 7 | |
| Polyester 8 | 6 | | | | | | |
| Eutomer B31 | 1 | 1 | 1 | 1.5 | 1.8 | 1.2 | 1.3 |
| BYK 3900 P | 1 | 1 | 1 | 1 | 1 | 1 | 1 |
| Lanco TF 1778 | 1 | 1 | 1 | 1 | 1 | 1 | 1 |
| Tioxide TR81 | 30 | 30 | 30 | 30 | 30 | 30 | 30 |
| Portafill A 40 | 2.5 | 2.5 | 2.5 | 0.5 | 0.2 | 2.3 | 2.2 |

TABLE 11
Test results for Examples 13) to 19)

| | Example 13 | Example 14 | Example 15 | Example 16 | Example 17 | Example 18 | Example 19 |
|---|---|---|---|---|---|---|---|
| Aliphatics content with | 13.3% | 16.0% | 19.9% | 21.2% | 23.3% | 23.3% | 23.9% |
| respect to A) and C) | | | | | | | |

Tests

| | | | | | | | |
|---|---|---|---|---|---|---|---|
| Gel time at 130° C. [sec] | 122 | 127 | 144 | 193 | 157 | 138 | 117 |

MDF sample (4 min 150° C.)

| | | | | | | | |
|---|---|---|---|---|---|---|---|
| Coat thickness [μm] 5 | 160 | 160 | 170 | 130 | 160 | 150 | 130 |
| Water swelling test | Cracking | >12 h | >12 h | >12 h | >12 h | >12 h | >12 h |
| at room temperature | after 4 h | | | | | | |
| (25° C., in conformity | | | | | | | |
| with IOS-TM-0022) | | | | | | | |

Surprisingly, it has been shown that the required resistance in the water swelling test is only achieved from a specific aliphatics content. From Examples 13) to 19), it can be shown that the aliphatics content has to be at least 15% by weight in order to pass the “more than 12 hours” water swelling test.

### Examples 20) to 26)

In Examples 20) to 26), larger quantities of component C) were employed, meaning that the linear aliphatic dicarboxylic acids content and the linear aliphatic diols content was also higher, with respect to the total quantity of polyester resins used. In Examples 20) to 26), the aliphatics content was in the range from 42.5% to 76.1% by weight.

TABLE 12
Examples 20) to 26)

| Component | Example 20 | Example 21 | Example 22 | Example 23 | Example 24 | Example 25 | Example 26 |
|---|---|---|---|---|---|---|---|
| Polyester 1 | 25.9 | 24.4 | 21.6 | 23.7 | 19.8 | 16 | 12.1 |
| D.E.R. 642U | 22.6 | 22.1 | 26.9 | 22.3 | 21.2 | 20 | 18.9 |
| Sirales PE 5900 | 16 | 18 | 16 | 20 | 25 | 30 | 35 |
| Aradur 835 | | | 4 | | | | |
| Eutomer B31 | 1.5 | 1.5 | 1.8 | 1.5 | 1.5 | 2.5 | 2.5 |
| BYK 3900 P | 1 | 1 | 1 | 1 | 1 | 1 | 1 |
| Lanco TF 1778 | 1 | 1 | 1 | 1 | 1 | 1 | 1 |
| Tioxide TR81 | 30 | 30 | 27.7 | 30 | 30 | 29.5 | 29.5 |
| Portafill A 40 | 2 | 2 | | 0.5 | 0.5 | | |

In tests 20) to 26), the requirements for reactivity and crack resistance could be satisfied. The stability upon storage surprisingly reduced beyond an aliphatics content of 50% by weight, could still be assessed as acceptable at an aliphatics content of 60% to 75% by weight, and beyond an aliphatics content of 75% was no longer acceptable.

TABLE 13
Test results for Examples 20) to 26)

| | Example 20 | Example 21 | Example 22 | Example 23 | Example 24 | Example 25 | Example 26 |
|---|---|---|---|---|---|---|---|
| Aliphatics content with | 42.5% | 46.5% | 46.6% | 49.6% | 58.9% | 67.7% | 76.1% |
| respect to A) and C) | | | | | | | |

Tests

| | | | | | | | |
|---|---|---|---|---|---|---|---|
| Gel time at 130° C. [sec] | 163 | 150 | 180 | 170 | 192 | 185 | 197 |

MDF sample (4 min 150° C.)

| | | | | | | | |
|---|---|---|---|---|---|---|---|
| Coat thickness [μm] | 170 | 150 | 160 | 180 | 180 | 170 | 160 |
| Water swelling test | >12 h | >12 h | >12 h | >12 h | >12 h | >12 h | >12 h |
| at room temperature | | | | | | | |
| (25° C., in conformity | | | | | | | |
| with IOS-TM-0022) | | | | | | | |
| Physical stability | Very | Very | Very | Very | Good | acceptable | Not |
| upon storage | good | good | good | good | | | acceptable |

### Examples 27) to 28)

In Examples 27) and 28), the influence of special amine-containing hardeners as component E) was demonstrated. The tested components E), Aradur 835 and Ancamine 2014AS (Air products), each contained polyamine compounds.

TABLE 14
Examples 27) and 28)

| Component | Example 27 | Example 28 |
|---|---|---|
| Polyester 1 | 26 | 26 |
| D.E.R. 642U | 25.5 | 25.5 |
| Polyester 7 | 9 | 9 |
| Aradur 835 | 3 | |
| Ancamine 2014AS | | 3 |
| Eutomer B31 | 1.5 | 1.8 |
| BYK 3900 P | 1 | 1 |
| Lanco TF 1778 | 1 | 1 |
| Tioxide TR81 | 25 | 25 |
| Portafill A 40 | 8 | 7.7 |

As can be seen from Examples 1) to 6) and 9) to 12), after storage for two weeks at 30° C., a gel time reduction of approximately 40% to 50 c was observed. These powder coatings satisfy the requirements for a maximum of 50% of gel time reduction after storage for two weeks at 30° C. and can in principle be processed, but might require cool storage and cooled transport in order to maintain a sufficient storage period.

In a particular embodiment of the invention, it was surprisingly observed that adding special hardeners which contain amine compounds results in a considerable improvement in the stability upon storage. As can be seen from Examples 8), 27) and 28), by adding these hardeners as component E), the gel time reduction for the powder coating after storage at 30° C. for two weeks can be reduced to approximately 10% to 35%.

TABLE 15
Test results for Examples 27) and 28)

| | Example 27 | Example 28 |
|---|---|---|
| Aliphatics content with respect to A) and C) | 30.93% | 30.93% |

Tests

| | | |
|---|---|---|
| Gel time at 130° C. [sec] | 171 | 188 |

Stability upon storage - after storage at 30° C.

| | | |
|---|---|---|
| Gel time (130° C.) after 14 days [sec] | 120 | 124 |

1-22. (canceled)

23. Powder coating compositions containing a binder combination, characterized in that the binder combination comprises the following components:
A) 15% to 70% by weight of the binder formed by one or more amorphous polyester resins containing carboxy groups, with an arithmetically averaged acid value of 50 to 100 mg KOH/g,
B) 20% to 50% by weight of the binder formed by one or more polymers containing epoxy groups with an arithmetically averaged epoxy equivalent weight of 350 to 650 g/eq,
C) 5% to 55% by weight of the binder formed by one or more crystalline or semi-crystalline polyester resins containing carboxy groups,
D) 0.5% to 6% by weight (with respect to the whole formulation) formed by one or more catalysts (accelerators) for the cross-linking reaction(s), and optionally
E) 0% to 10% by weight (with respect to the whole formulation) formed by one or more components containing reactive groups for cross-linking reaction(s) with the carboxy groups and/or epoxy groups of the components A), B) and C),
wherein the polyester resins in accordance with A) and C) contain a total of 15% to 75% by weight with respect to the monomers used for the synthesis of linear and unbranched aliphatic dials or their derivatives and/or linear and unbranched aliphatic dicarboxylic acids or their derivatives.

24. The powder coating composition of claim 23, wherein the polymer in accordance with B) is based on bisphenol A and phenol novolak.

25. The powder coating composition of claim 23, wherein the polyester resin in accordance with C) comprises an arithmetically averaged acid value of 15 to 100 mg KOH/g.

26. The powder coating composition as claimed in claim 23, characterized in that the polyester resin in accordance with C) has a melting point or range of 60° C. to 130° C.

27. The powder coating composition of claim 23, characterized in that the polyester resin in accordance with A) has a Tg of 35° C. to 80° C.

28. The powder coating composition claim 23, characterized in that the linear and unbranched aliphatic diols and/or aliphatic dicarboxylic acids do not contain any double and/or triple bonds in their carbon chains.

29. The powder coating composition claim 23, characterized in that the polyester resin in accordance with C) has an aromatics content of less than 50 mol % with respect to the monomers employed.

30. The powder coating composition claim 23, characterized in that the polyester resin in accordance with C) has a viscosity of 0.01 to 10 Pa*s, measured using the cone & plate method.

31. The powder coating composition claim 23, characterized in that the binder composition and the catalysts in accordance with D) do not contain any organotin-containing components.

32. The powder coating composition claim 23, which contain an appropriate quantity of one or more catalysts (accelerators) of the cross-linking reaction(s) for producing a gel time of 50 to 240 sec at 130° C., wherein the gel time measurement is carried out in conformity with ÖNRM EN ISO 8130-6 and the time measurement is started immediately after transferring the powder coating test portion into the depression in the heated block.

33. The powder coating composition claim 23, characterized in that the (semi)crystalline polyester(s) in accordance with C) contain succinic acid and/or its anhydrides and/or derivatives as the polycarboxylic acid.

34. The powder coating composition claim 23, characterized in that it contains 1,4-butanediol as the component C).

35. The powder coating composition claim 23, characterized in that 1,4-butanediol is used as the polyol of the polyester resin in accordance with C) in an amount of more than 50 mol %, and succinic acid and/or its anhydrides and/or its derivatives is used as the polycarboxylic acid in an amount of more than 50 mol %.

36. The powder coating composition claim 23, characterized in that 30% to 100% by weight of component B) consists of a hydrogenated epoxy resin.

37. The powder coating composition claim 23, characterized in that it contains polyamine compounds and/or polyamine adducts as component E).

38. The powder coating composition claim 23, characterized in that it contains 0.3% to 2.0% by weight (with respect to the total formulation) of 2-phenyl-2-imidazoline as the catalyst (component D).

39. The powder coating composition claim 23, characterized in that it contains 0.1% to 1.0% by weight (with respect to the total formulation) of phosphonium salts and/or ammonium salts as the catalysts (component D).

40. The powder coating composition of claim 39, wherein the phosphonium salt and/or ammonium salt is ethyltriphenyl phosphonium bromide.

41. The powder coating composition claim 23, characterized in that it contains 0.1% to 3.0% by weight (with respect to the total formulations) of imidazoles as the catalysts (component D).

42. The powder coating composition claim 23, characterized in that it is produced as a single-component powder coating.

43. The powder coating composition claim 23, characterized in that for an at least 80 μm thick coating on 19 mm thick MDF board, the “more than 12 hours without cracking” water swelling test in conformity with IKEA test standard IOS-TM-0022 is passed for 24 hours without cracking.

44. A method for the manufacture of a powder coating composition of claim 23, characterized in that the component C) and/or component D) in one of the binders or a combination of binders as well as other powder coating components if appropriate is pre-distributed by extrusion, wherein the extruded product is then used as the raw material for the powder coating manufacture.

45. Use of a powder coating composition of claim 23 for coating substrates, in particular for coating temperature-sensitive substrates formed from plastics and wood materials such as, for example LDF, MDF, HDF, particle board, OSB, BOF (board of frame), plywood, thermo wood, solid wood and WPC) as a single layer topcoat or after prior coating with a base coat.

46. Use of a powder coating composition of claim 23 for coating substrates and subsequent over-painting with a powder coating and/or liquid coating and/or other coating agent such as toners and tints.

47. Use of a powder coating composition of claim 23 for coating wood or wood-based substrates such as LDF, MDF, HDF, particle board, OSB, BOF (hoard of frame), plywood, thereto wood, solid wood and WPC. 74914828.1 6
